(19) United States
(12) Patent Application Publication
(10) Pub. No.: US 2014/0340428 A1
(43) Pub. Date: Nov. 20, 2014

(54) MOVING IMAGE REPRODUCING APPARATUS AND METHOD FOR CONTROLLING THE SAME

(71) Applicant: CANON KABUSHIKI KAISHA, Tokyo (JP)

(72) Inventor: Yoshinobu Shibayama, Kawasaki-shi (JP)

(73) Assignee: CANON KABUSHIKI KAISHA, Tokyo (JP)

(21) Appl. No.: 14/279,060

(22) Filed: May 15, 2014

(30) Foreign Application Priority Data
May 17, 2013 (JP) 2013-105331

(51) Int. Cl. G06T 3/60

(52) U.S. Cl. CPC G06T 3/60
USPC 345/659

(57) ABSTRACT

A moving image reproducing apparatus includes a reproduction unit configured to reproduce moving image data, a display control unit configured to control a display unit to display a moving image relating to the moving image data reproduced by the reproduction unit, a detection unit configured to detect an orientation of the display unit, and a control unit configured to, if the detection unit has detected a change in the orientation of the display unit while the reproduction unit reproduces the moving image data, control the reproduction unit to start reproducing the moving image data from a reproduction position prior to a reproduction position at a point of time when the detection unit has detected the change in the orientation.

### BACKGROUND OF THE INVENTION

1. Field of the Invention

The present invention relates to a moving image reproducing apparatus particularly suitable for displaying moving images and a method for controlling the moving image reproducing apparatus.

2. Description of the Related Art

Conventionally, there is a method for comparing the orientation of a display apparatus with an orientation flag that represents the vertical direction of an image added to the image and, if the longitudinal direction of the image does not match that of the display apparatus, rotating and zooming the image so that the entire image can be displayed (see Japanese Patent Application Laid-Open No. 2000-312329).

According to the method discussed in Japanese Patent Application Laid-Open No. 2000-312329, when a vertically-long image is displayed within a horizontally-long display area, the image is reduced to a size so that the height of the image fits within the horizontally-long display area. As a result, since the image is displayed as a small image, the user cannot easily view the displayed image. To address such inconvenience, the user can enlarge the image by rotating the reproducing apparatus so that the longitudinal direction of the display area of the reproducing apparatus matches the longitudinal direction of the image. However, if the user rotates the reproducing apparatus during display of a moving image, by the time the user completes the rotation of the reproducing apparatus, the reproduction of the moving image has already progressed. Thus, the user can only view the small moving image during a period from when the reproduction of the moving image is started to when the rotation of the reproducing apparatus is completed. If the user wishes to view the moving image, which was viewed during the period from when the reproduction of the moving image is started to when the rotation of the reproducing apparatus is completed, in an enlarged state which is the same as that after the reproducing apparatus is rotated, the user needs to rewind the moving image. However, such operation increases the number of operations, thereby deteriorating user-friendliness.

### SUMMARY OF THE INVENTION

The present invention is directed to a technique for preventing a user from failing to grasp the content of a moving image if the user rotates an apparatus while the apparatus is reproducing the moving image.

According to an aspect of the present invention, a moving image reproducing apparatus includes a reproduction unit configured to reproduce moving image data, a display control unit configured to control a display unit to display a moving image relating to the moving image data reproduced by the reproduction unit, a detection unit configured to detect an orientation of the display unit, and a control unit configured to, if the detection unit has detected a change in the orientation of the display unit while the reproduction unit is reproducing the moving image data, control the reproduction unit to start reproducing the moving image data from a reproduction position prior to a reproduction position at a point of time when the detection unit has detected the change in the orientation.

Further features of the present invention will become apparent from the following description of exemplary embodiments with reference to the attached drawings.

### BRIEF DESCRIPTION OF THE DRAWINGS

FIG. 1 illustrates an example of an external configuration of a moving image reproducing apparatus according to an exemplary embodiment of the present invention.

FIG. 2 is a block diagram illustrating an example of an internal configuration of the moving image reproducing apparatus according to an exemplary embodiment of the present invention.

FIGS. 3A to 3G illustrate an example of progress of moving image display performed by a moving image reproducing apparatus according to first and second exemplary embodiments of the present invention.

FIG. 4 is a flowchart illustrating an example of a procedure for displaying a moving image performed by the moving image reproducing apparatus according to the first exemplary embodiment of the present invention.

FIG. 5 is a flowchart illustrating an example of a procedure for displaying a moving image performed by the moving image reproducing apparatus according to the second exemplary embodiment of the present invention.

FIGS. 6A to 6H illustrate progress of moving image display performed by g a moving image reproducing apparatus according to a third exemplary embodiment of the present invention.

FIG. 7 is a flowchart illustrating an example of a procedure for displaying a moving image performed by the moving image reproducing apparatus according to the third exemplary embodiment of the present invention.

FIG. 8 is a flowchart illustrating an example of a procedure for displaying a moving image performed by the moving image reproducing apparatus according to the third exemplary embodiment of the present invention.

### DESCRIPTION OF THE EMBODIMENTS

An exemplary embodiment of the present invention will be described in detail below with reference to the accompanying drawings. It is to be noted that the following exemplary embodiment is merely one example for implementing the present invention and can be appropriately modified or changed depending on individual constructions and various conditions of apparatuses to which the present invention is applied. Thus, the present invention is in no way limited to the following exemplary embodiment.

The following exemplary embodiments will be described by using a digital camera having an imaging unit as an example.

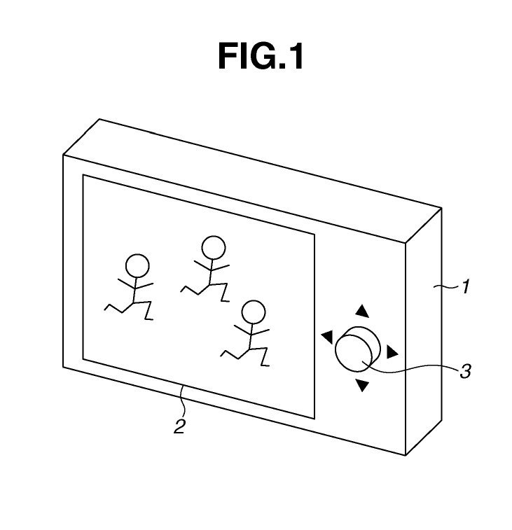

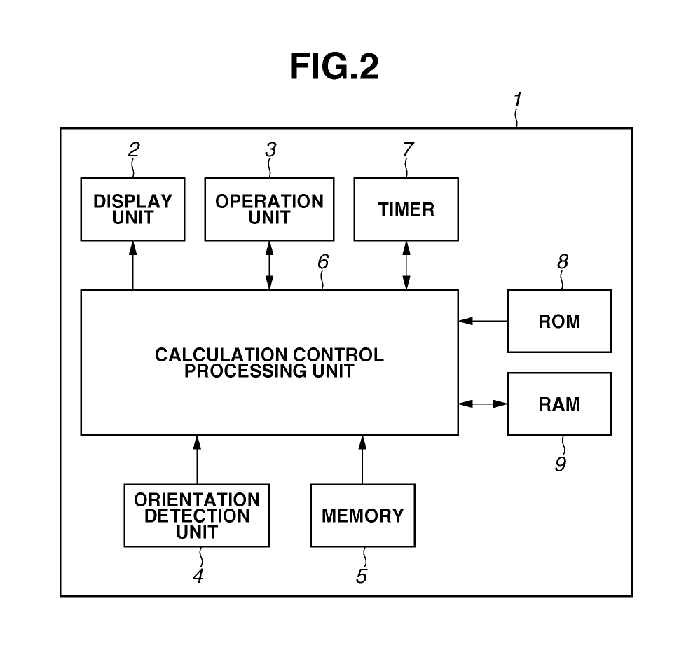

FIG. 1 illustrates an external configuration of a moving image reproducing apparatus 1 according to a first exemplary embodiment of the present invention. FIG. 2 is a block diagram illustrating an internal configuration of the moving image reproducing apparatus 1 according to the present exemplary embodiment.

With reference to FIGS. 1 and 2, a display unit 2 is arranged on one surface of the moving image reproducing apparatus 1 and has a horizontally-long display area. When displaying a horizontally-long moving image, the display unit 2 displays the moving image across the entire display area. By tilting an operation unit 3 in the left, right, top, or bottom direction, the user can select an icon displayed on the display unit 2. In addition, by pushing in the operation unit 3 at the neutral position thereof, the user can confirm the selection of the icon to cause the moving image reproducing apparatus 1 to perform an operation corresponding to the selected icon.

An orientation detection unit 4 is a sensor such as an acceleration sensor or a vertical/horizontal direction detection sensor. The orientation detection unit 4 can detect the orientation of the main body of the moving image reproducing apparatus 1 (particularly, the direction of the display unit 2) with respect to the direction of gravitational force. More specifically, the orientation detection unit 4 detects, as apparatus orientation information, any one of the following four orientations: a first orientation in which a long side of the main body of the moving image reproducing apparatus 1 faces up, a second orientation in which the moving image reproducing apparatus 1 is turned upside down from the first orientation, a third orientation in which a short side of the main body of the moving image reproducing apparatus 1 faces up, and a fourth orientation in which the moving image reproducing apparatus 1 is turned upside down from the third orientation. The orientation detection unit 4 detects a change from the first orientation (second orientation) to the third orientation (fourth orientation) or from the third orientation (fourth orientation) to the first orientation (second orientation) when the main body of the moving image reproducing apparatus 1 is rotated approximately 45° or more from the horizontal state in each of the orientations. Then, a calculation control processing unit 6 (described below) acquires the apparatus orientation information from the orientation detection unit 4.

A memory 5 stores moving image data to be reproduced by the moving image reproducing apparatus 1. When the moving image reproducing apparatus 1 reproduces moving image data stored in the memory 5, the calculation control processing unit 6 acquires vertical direction information added to the moving image data. Next, the calculation control processing unit 6 compares the vertical direction of a moving image based on the vertical direction information added to the moving image data with the orientation of the moving image reproducing apparatus 1 detected by the orientation detection unit 4. Then, the calculation control processing unit 6 performs image processing, such as changing the size of and rotating the moving image data, so that the moving image can be displayed in a state where the vertical direction of the moving image matches the direction of gravitational force, and then transmits the moving image data to the display unit 2. In addition, the calculation control processing unit 6 performs other calculation processing and comprehensively controls the moving image reproducing apparatus 1. A timer 7 counts time from various operation start timings.

In addition, the moving image reproducing apparatus 1 includes a read-only memory (ROM) 8 storing a program used for performing the processing to be described below and a random access memory (RAM) 9 for loading the program.

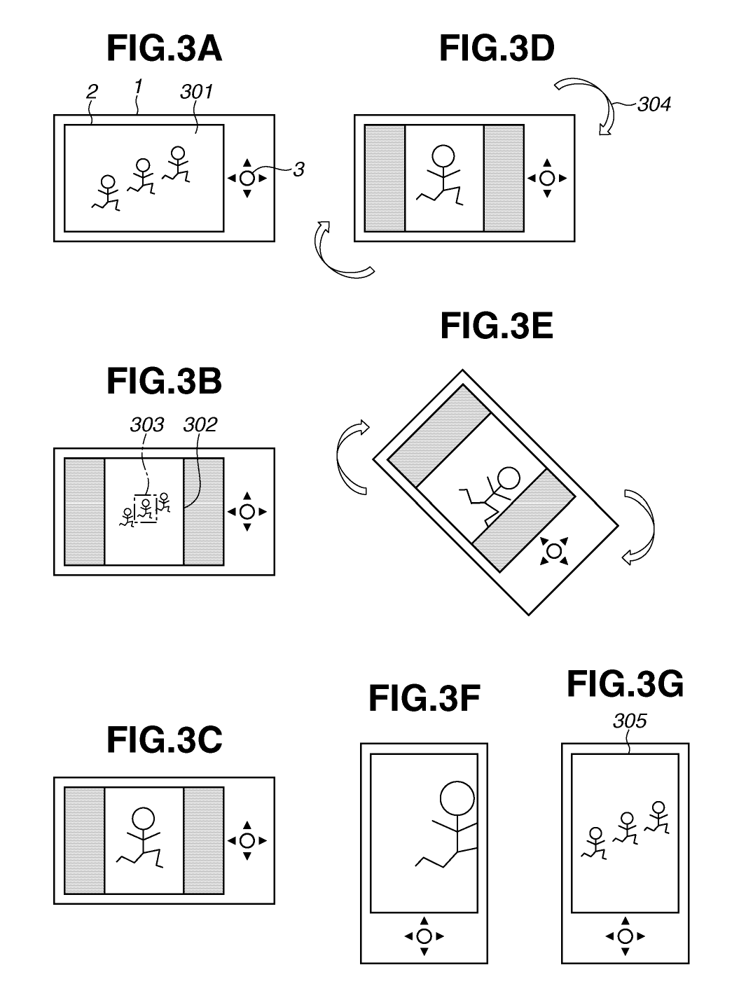

FIGS. 3A to 3G illustrate progress of moving image display performed by the moving image reproducing apparatus 1 according to the present exemplary embodiment. A display method according to the present exemplary embodiment will be described step by step with reference to FIGS. 3A to 3G.

FIG. 3A illustrates an example of a horizontally-long moving image 301 being displayed on the display unit 2 of the moving image reproducing apparatus 1. In this state, the longitudinal direction based on the vertical direction information of the horizontally-long moving image 301 matches the longitudinal direction of the display unit 2 in a current orientation. Thus, the horizontally-long moving image 301 is displayed across the entire screen of the display unit 2.

In an example illustrated in FIG. 3B, after the moving image data has been changed, a vertically-long moving image 302 is displayed on the display unit 2 of the moving image reproducing apparatus 1. In this state, the vertically-long moving image 302 displayed on the display unit 2 is an image obtained after the calculation control processing unit 6 performs size change processing and rotation processing so that the vertical direction based on the vertical direction information of the vertically-long moving image 302 matches the direction of gravitational force based on the orientation of the moving image reproducing apparatus 1. Namely, since the moving image reproducing apparatus 1 remains in the horizontally-long orientation, the size of the displayed vertically-long moving image 302 is reduced so that the long sides of the vertically-long moving image 302 match the short sides of the display unit 2. Consequently, non-display areas are inserted on the left and right sides of the vertically-long moving image 302.

FIG. 3C illustrates an example of a state where the vertically-long moving image 302 continues to be displayed, and an enlargement area 303 is zoomed in from the state illustrated in FIG. 3B by a zooming operation performed by the user during shooting. However, since the vertically-long moving image 302 has been reduced so that the vertical direction of the moving image data matches the orientation of the moving image reproducing apparatus 1, the enlargement area 303 is still small with respect to the screen of the display unit 2. Thus, the user viewing the vertically-long moving image 302 rotates the moving image reproducing apparatus 1 in a direction indicated by an arrow 304 illustrated in FIG. 3D so that the display unit 2 is in the vertically-long orientation.

FIG. 3E illustrates an example of the moving image reproducing apparatus 1 that has been rotated by less than approximately 45°. In this state, since the moving image reproducing apparatus 1 has not yet been rotated by a predetermined rotation angle or more, the direction of the vertically-long moving image 302 displayed on the display unit 2 has not been changed. In the present exemplary embodiment, when the moving image reproducing apparatus 1 is rotated by 45° or more, the orientation detection unit 4 detects a change in the orientation of the moving image reproducing apparatus 1. In addition, since the reproduction of the vertically-long moving image 302 progresses while the user is rotating the moving image reproducing apparatus 1, the scene progresses and the object is moved to the right side within the frame.

In examples illustrated in FIGS. 3F and 3G, the moving image reproducing apparatus 1 has been rotated by 90° and the display unit 2 has a vertically-long shape. In addition, the vertically-long moving image 302 is displayed to have a correct vertical direction based on the orientation of the moving image reproducing apparatus 1. Thus, the longitudinal direction of the vertically-long moving image 302 matches the longitudinal direction of the display unit 2, and the vertically-long moving image 305 is displayed across the entire screen of the display unit 2.

FIG. 3F illustrates an example of display in which the reproduction of the moving image data progresses further than the scene in FIG. 3C. Since the vertically-long moving image illustrated in FIG. 3F is obtained after the reproduction further progresses, the position of the object in the moving image is moved and a part of the object is out of the frame. Thus, the object is displayed on the right side within the screen frame, as compared to that displayed in FIG. 3C. Thus, when the reproduction of the moving image data progresses to the state illustrated in FIG. 3C, if the user rotates the moving image reproducing apparatus 1 to display the moving image across the entire screen, the reproduction of the moving image data has already progressed to the display example illustrated in FIG. 3F. In other words, even if the user rotates the moving image reproducing apparatus 1 with the intention of enlarging and viewing the object displayed in FIG. 3C, since the reproduction of the moving image data has already progressed, the user may not be able to view the scene including the target object in an enlarged manner.

To address such inconvenience, in the present exemplary embodiment, when the user rotates the moving image reproducing apparatus 1 to display the moving image across the entire screen, the moving image reproducing apparatus 1 brings back the reproduction position of the moving image data to a certain extent and starts reproducing the moving image data from that position. Thus, an object displayed when the user starts rotating the moving image reproducing apparatus 1 with the intention of enlarging and viewing the object can be enlarged and displayed just as the user intended.

For example, when the reproduction of the moving image data progresses as illustrated in FIG. 3C, if the user rotates the moving image reproducing apparatus 1, the moving image reproducing apparatus 1 brings back the reproduction position of the moving image data to the position of the display example illustrated in FIG. 3B. Then, the moving image reproducing apparatus 1 reproduces the moving image data in a state it can be displayed across the entire screen as illustrated in FIG. 3G. As will be described below, there is a plurality of ways for bringing back the reproduction position. For example, the reproduction position may be brought back to the first frame of the moving image data currently reproduced. Alternatively, the reproduction position may be brought back to a frame that is a predetermined time earlier than a frame at a point of time when the moving image reproducing apparatus 1 has been rotated (when the orientation thereof has been changed).

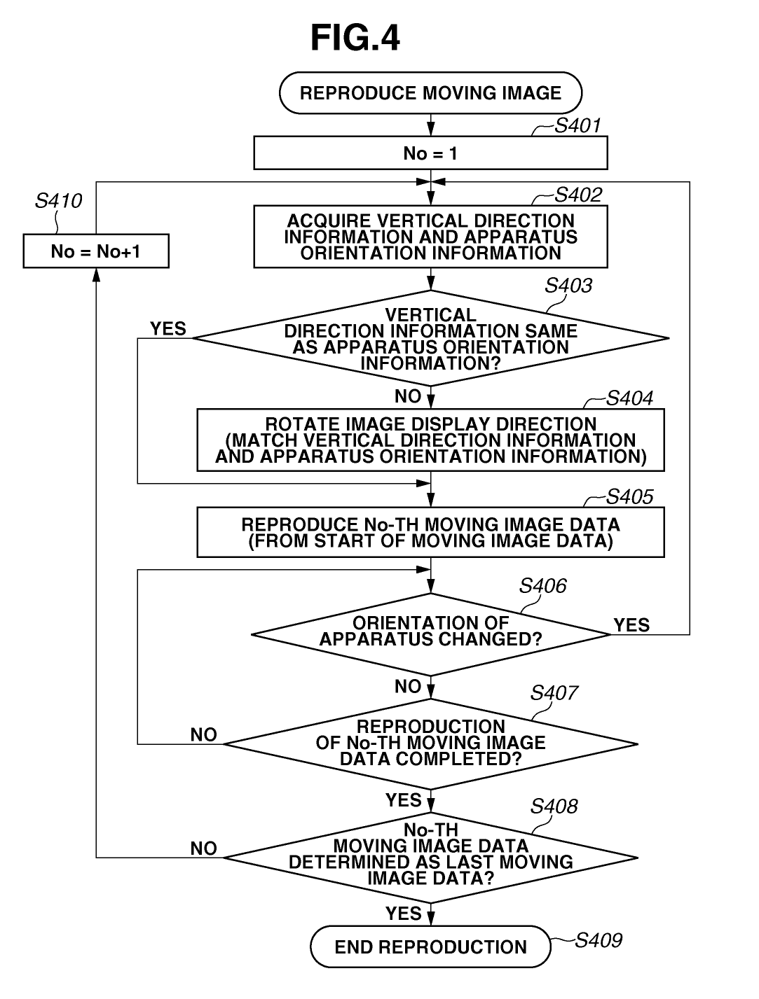

FIG. 4 is a flowchart illustrating an example of a procedure for displaying a moving image performed by the moving image reproducing apparatus 1 according to the present exemplary embodiment. Each processing illustrated in FIG. 4 is performed under control of the calculation control processing unit 6. Specifically, a program stored in the ROM 8 is loaded into the RAM 9, and processing relating to the program is performed.

First, in step S401, the calculation control processing unit 6 specifies start data for continuously reproducing a plurality of pieces of moving image data. In the present exemplary embodiment, the calculation control processing unit 6 sets a single numerical value. The value “No” represents n-th moving image data when the plurality of pieces of moving image data is arranged in the order of reproduction. If No=1 is specified, the moving image reproducing apparatus 1 starts reproducing the first moving image data among the plurality of pieces of moving image data to be continuously reproduced.

Next, in step S402, the calculation control processing unit 6 acquires vertical direction information about the moving image data to be reproduced. In addition, the orientation detection unit 4 detects the current orientation of the moving image reproducing apparatus 1. The calculation control processing unit 6 acquires the apparatus orientation information from the orientation detection unit 4. Next, in step S403, the calculation control processing unit 6 determines whether the direction indicated by the vertical direction information is the same as the direction indicated by the apparatus orientation information. As a result of the determination, if the directions are the same (YES in step S403), the operation proceeds to step S405. If the directions are different (NO in step S403), the operation proceeds to step S404. In step S404, to rotate the display of the moving image, the calculation control processing unit 6 performs, for example, rotation/reduction processing on the reproduction-target moving image data so that the vertical direction information matches the apparatus orientation information.

If the vertical direction information matches the apparatus orientation information, the reproduction-target moving image is displayed as illustrated in FIG. 3A or FIG. 3B. If the moving image is vertically long, the moving image is reduced so that the long sides of the vertically-long moving image 302 match the short sides of the display unit 2, and non-display areas are inserted on the left and right sides of the vertically-long moving image 302 on the display unit 2. If the moving image reproducing apparatus 1 is in a vertically long orientation and the moving image is vertically long, the vertically-long moving image 302 is displayed across the entire screen of the display unit 2. If the moving image reproducing apparatus 1 is in a vertically long orientation and the moving image is horizontally long, the moving image is reduced so that the long sides of the horizontally-long moving image match the short sides of the display unit 2, and non-display areas are inserted on the top and bottom sides of the display unit 2.

Next, in step S405, the calculation control processing unit 6 reproduces the moving image data from the start and display it on the display unit 2. In this way, the user can view, without troublesome operations, a moving image preceding the moving image displayed when the orientation of the moving image reproducing apparatus 1 is rotated, in a display direction set after the orientation of the moving image reproducing apparatus 1 is rotated.

In the present exemplary embodiment, when the orientation of the moving image reproducing apparatus 1 is changed and the display direction of a moving image is rotated, the reproduction position of the moving image being currently reproduced is brought back to the first frame. However, the present invention is not limited to such example. Instead of bringing back the reproduction position of the moving image when the orientation of the moving image reproducing apparatus 1 is changed and the display direction of the moving image is rotated, a message for asking the user whether to bring back the reproduction position of the moving image data may be displayed. For example, a message “bring back the reproduction position?” and icons for selecting “Yes” or “No” may be displayed on the display unit 2. In this way, if the user selects the icon representing “Yes”, the moving image reproducing apparatus 1 brings back the reproduction position.

Next, in step S406, the calculation control processing unit 6 determines whether the apparatus orientation information has been changed. As a result of the determination, if the calculation control processing unit 6 determines that the apparatus orientation information has not been changed (NO in step S406), the calculation control processing unit 6 determines that the apparatus orientation information about the moving image reproducing apparatus 1 still matches the vertical direction information about the moving image data, and the operation proceeds to step S407. On the other hand, as a result of the determination in step S406, if the calculation control processing unit 6 determines that the apparatus orientation information has been changed (YES in step S406), the calculation control processing unit 6 determines that the moving image reproducing apparatus 1 has been rotated and the apparatus orientation information about the moving image reproducing apparatus 1 does not match the vertical direction information about the moving image data. Thus, the operation returns to step S02, and the above steps S402 to S406 are repeated.

Next, in step S407, the calculation control processing unit 6 determines whether the reproduction of the first moving image data has been completed. As a result of the determination, if the calculation control processing unit 6 determines that the reproduction has been completed (YES in step S407), the operation proceeds to step S408. If not (NO in step S407), the operation returns to step S406. Next, in step S408, the calculation control processing unit 6 determines whether the moving image data that has been reproduced is the last moving image data. If the calculation control processing unit 6 determines that the moving image data that has been reproduced is the last moving image data (YES in step S408), the operation proceeds to step S409, and the reproduction processing ends. On the other hand, as a result of the determination in step S408, if the calculation control processing unit 6 determines that the moving image data that has been reproduced is not the last moving image data (NO in step S408), the operation proceeds to step S410. In step S410, the calculation control processing unit 6 sets No=No+1 to reproduce the next moving image data, and the operation returns to step S402.

As described above, according to the present exemplary embodiment, if the moving image reproducing apparatus 1 is rotated in a state where the size of the moving image is reduced so that the orientation of the moving image reproducing apparatus 1 matches the vertical direction of the moving image, the user can view the moving image from the start without missing a scene.

Next, a second exemplary embodiment of the present invention will be described. Since a moving image reproducing apparatus according to the present exemplary embodiment has a similar configuration to that illustrated in FIGS. 1 and 2, the description thereof will be omitted.

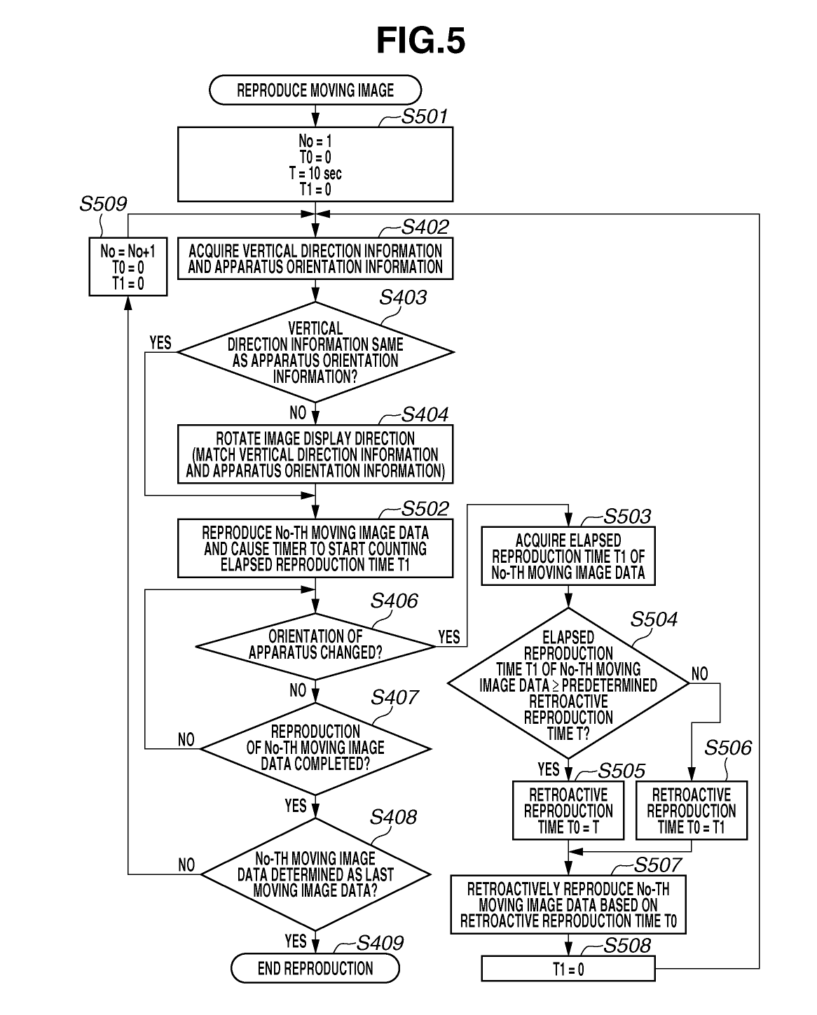

FIG. 5 is a flowchart illustrating an example of a procedure for displaying a moving image performed by the moving image reproducing apparatus 1 according to the present exemplary embodiment. Each processing illustrated in FIG. 5 is performed under control of the calculation control processing unit 6. Specifically, a program stored in the ROM 8 is loaded into the RAM 9, and processing relating to the program is performed. In addition, the flowchart in FIG. 5 includes similar steps to those in the flowchart in FIG. 4, and these steps are denoted by the same reference numerals. Thus, in the present exemplary embodiment, only the steps different from those in FIG. 4 will be described.

First, in step S501, the calculation control processing unit 6 specifies start data for continuously reproducing a plurality of pieces of moving image data, and the operation proceeds to step S502. In the present exemplary embodiment, the calculation control processing unit 6 sets four numerical values. The value “No” is similar to that in the first exemplary embodiment. The value “T0” is a retroactive reproduction time. More specifically, the retroactive reproduction time T0 is an actual time by which moving image data is to be brought back when the orientation of the moving image reproducing apparatus 1 is changed to reproduce the moving image data. For example, when T0=0, an initial value for the retroactive reproduction time T0 is set to 0 so that the moving image data is brought back to its reproduction start time. A value for the retroactive reproduction time T0 is set in step S505 or S506 (described below).

The value “T” is a predetermined retroactive reproduction time. The predetermined retroactive reproduction time T determines a maximum time by which reproduction of moving image data can be brought back. In the present exemplary embodiment, T=10 (sec) is specified and moving image data is brought back by 10 seconds at a maximum and is then reproduced. This value is used for calculating the retroactive reproduction time in step S504 (described below). In addition, the value “T1” is an elapsed reproduction time of the No-th moving image data. The elapsed reproduction time T1 represents how much time the No-th moving image data has been reproduced. By setting a timer, which starts counting when moving image data is reproduced, to T1=0, the initial value for the timer, which counts from the start of reproducing the moving image data, is set to 0 (described below). Since steps S402 to S404 are similar to those in the first exemplary embodiment, the description thereof will be omitted.

Next, in step S502, the calculation control processing unit 6 starts reproducing the No-th moving image data and causes the timer 7 to count the elapsed reproduction time T1 of the moving image data. In step S406, similar processing to that in the first exemplary embodiment is performed. Namely, if the apparatus orientation information has not been changed (NO in step S406), the operation proceeds to step S407. Since steps S407 to S408 are similar to those in the first exemplary embodiment, the description thereof will be omitted. As a result of the determination in step S406, if the calculation control processing unit 6 determines that the apparatus orientation information has been changed (YES in step S406), the operation proceeds to step S503. In step S503, the calculation control processing unit 6 acquires information about the elapsed reproduction time T1 representing how much time the currently-reproduced moving image data has been reproduced.

Next, in step S504, the calculation control processing unit 6 determines whether the elapsed reproduction time T1 of the currently-reproduced moving image data is equal to or more than the above-described predetermined retroactive reproduction time T. As a result of the determination, if the calculation control processing unit 6 determines that the elapsed reproduction time T1 of the currently-reproduced moving image data is equal to or more than the predetermined retroactive reproduction time T, the operation proceeds to step S505. In step S505, the calculation control processing unit 6 sets the retroactive reproduction time T0 to the predetermined retroactive reproduction time T (10 seconds in the present exemplary embodiment).

If the reproduction position of moving image data is always brought back by the elapsed reproduction time T1 thereof, namely, back to the initial reproduction position thereof, the reproduction time may be excessively extended, resulting in long reproduction. Thus, in the present exemplary embodiment, if a predetermined time has elapsed since reproduction of moving image data, the retroactive reproduction time T0 is set to a maximum of 10 seconds, thereby preventing unnecessary extension of the reproduction time.

If, as a result of the determination in step S504, the calculation control processing unit 6 determines that the elapsed reproduction time T1 of the currently-reproduced moving image data is less than the predetermined retroactive reproduction time T (NO in step S504), the operation proceeds to step S506. In step S506, the calculation control processing unit 6 sets the retroactive reproduction time T0 to the elapsed reproduction time T1 of the No-th moving image data being currently reproduced. Since the elapsed reproduction time T1 of the No-th moving image data has not reached the predetermined retroactive reproduction time T, namely, is less than 10 seconds, it can be determined that the user is unlikely to care about the duration of the retroactive reproduction time.

Next, in step S507, the calculation control processing unit 6 performs a retroactive operation based on the set retroactive reproduction time T0. Then, in step S508, the calculation control processing unit 6 resets the elapsed reproduction time T1 of the moving image data to 0. Next, the operation returns to step S402 to restart reproduction from the position to which the moving image data has been returned when the reproduction of the moving image data is started in step S502.

If, as a result of the determination in step S408, the calculation control processing unit 6 determines that the moving image data that has been reproduced is not the last moving image data (NO in step S408), the operation proceeds to step S509. In step S509, the calculation control processing unit 6 sets No=No+1, T0=0, and T1=0. Then, the operation returns to step S402.

As described above, according to the present exemplary embodiment, if the moving image reproducing apparatus 1 is rotated in a state where the size of a moving image is reduced so that the orientation of the moving image reproducing apparatus 1 matches the vertical direction of the moving image, the moving image data is effectively reproduced without excessively extending the reproduction time, allowing the user to view the currently-reproduced moving image without missing a desired scene.

Next, a third exemplary embodiment of the present invention will be described. Since a moving image reproducing apparatus according to the present exemplary embodiment has a similar configuration to that illustrated in FIGS. 1 and 2, the description thereof will be omitted.

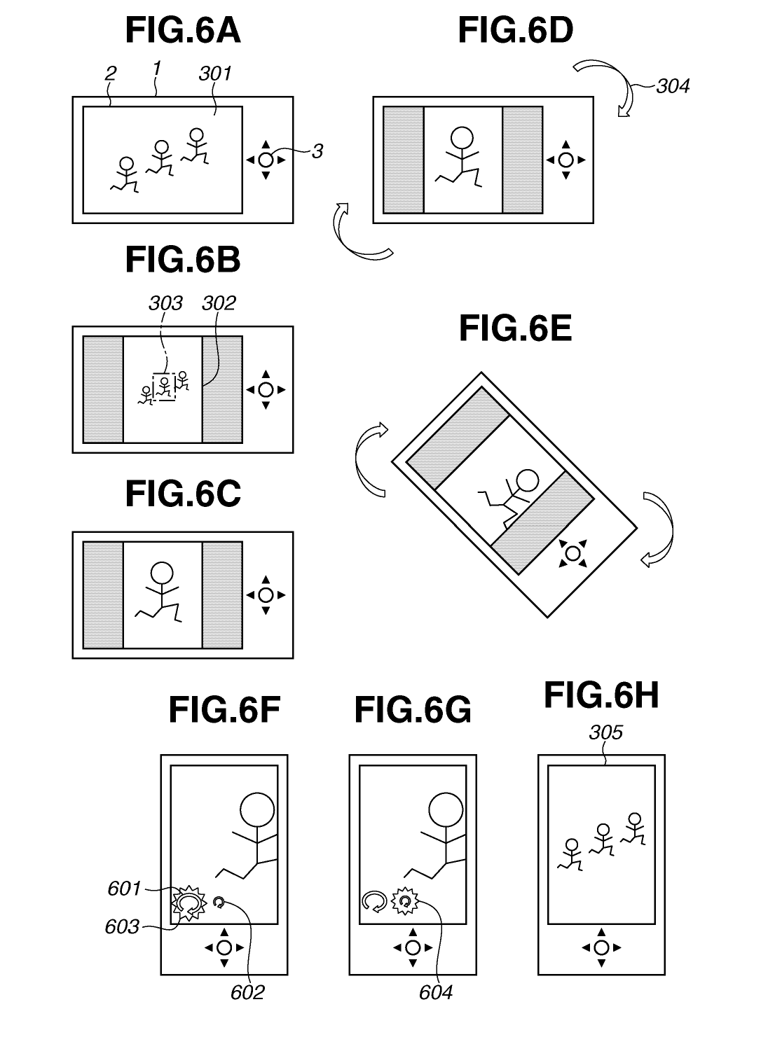

FIGS. 6A to 6H illustrate progress of moving image display performed by the moving image reproducing apparatus 1 according to the present exemplary embodiment. FIGS. 6A to 6E illustrate similar progress to that illustrated in FIG. 3A to FIG. 3E. If the state illustrated in FIG. 6E is changed to the state illustrated in FIG. 6H, the orientation detection unit 4 detects a change in the orientation as the apparatus orientation information. In the present exemplary embodiment, as illustrated in FIG. 6F or 6G, icons (display items) are displayed on the display unit 2.

In FIG. 6F, a first icon 601 is an icon for selecting a control operation for bringing back the reproduction position to the position when the horizontally-long moving image 301 has been changed to the vertically-long moving image 302, and reproducing the vertically-long moving image 302 from that position. A second icon 602 is an icon for selecting a control operation for bringing back the reproduction position by the retroactive reproduction time T0 described in the second exemplary embodiment and reproducing the vertically-long moving image 302 from that position. In an example illustrated in FIG. 6F, a first icon selection display 603 indicates that the first icon 601 has been selected. In contrast, in an example illustrated in FIG. 6G, a second icon selection display 604 indicates that the second icon 602 has been selected. When the orientation detection unit 4 has detected a change in the orientation as the apparatus orientation information, the operation unit 3 is enabled to receive a control operation for selecting an icon and a control operation for confirming the selection of an icon.

In addition, in the present exemplary embodiment, the first icon selection display 603 and the second icon selection display 604 are configured not to be simultaneously illuminated. Either the first icon selection display 603 or the second icon selection display 604 is selected. For example, if the operation unit 3 is pressed in the right direction while the first icon selection display 603 is selected as illustrated in FIG. 6F, the second icon selection display 604 is selected as illustrated in FIG. 6G. If the operation unit 3 is pressed in the left direction while the second icon selection display 604 is selected as illustrated in FIG. 6G, the first icon selection display 603 is selected as illustrated in FIG. 6F.

In addition, if the operation unit 3 is pressed in at the neutral position while the first icon selection display 603 is selected as illustrated in FIG. 6F, the selection of the first icon 601 is confirmed. Consequently, as illustrated in FIG. 6H, the moving image reproducing apparatus 1 brings back the reproduction position to the position when the horizontally-long moving image 301 has been changed to the vertically-long moving image 302, and reproduces the vertically-long moving image 305 from that position. In addition, if the operation unit 3 is pressed in at the neutral position while the second icon selection display 604 is selected as illustrated in FIG. 6G, the selection of the second icon 602 is confirmed. Consequently, the moving image reproducing apparatus 1 brings back the reproduction position of the vertically-long moving image 302 by the retroactive reproduction time T0, and reproduces the vertically-long moving image 305.

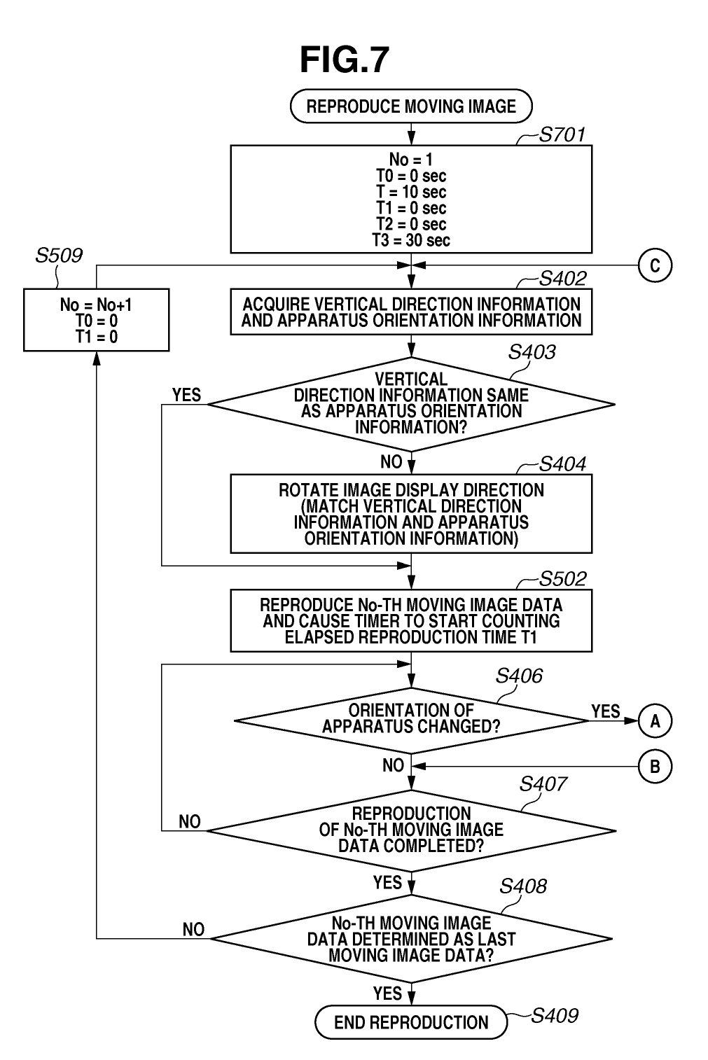

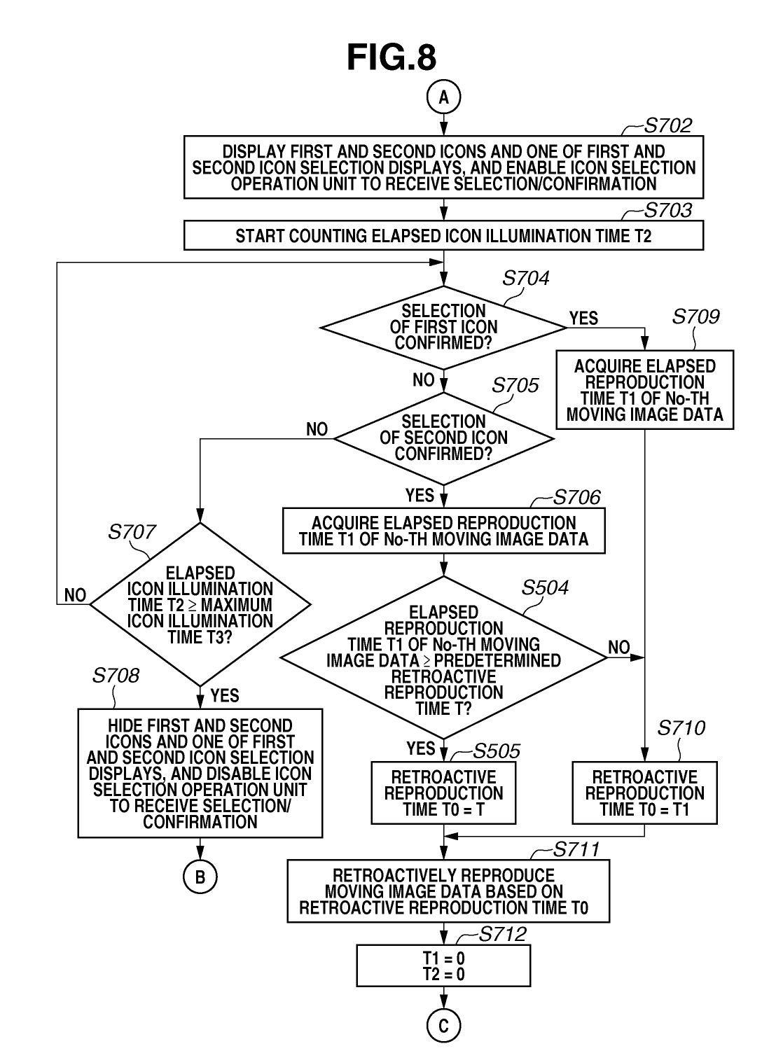

FIGS. 7 and 8 are flowcharts illustrating a procedure for displaying a moving image performed by the moving image reproducing apparatus 1 according to the present exemplary embodiment. Each processing illustrated in FIGS. 7 and 8 is performed under control of the calculation control processing unit 6. Specifically, a program stored in the ROM 8 is loaded into the RAM 9, and processing relating to the program is performed. In addition, the flowcharts in FIGS. 7 and 8 include similar steps to those in the flowcharts in FIGS. 4 and 5, and these steps are denoted by the same reference numerals. Thus, in the present exemplary embodiment, only the steps different from those in FIGS. 4 and 5 will be described.

First, in step S701 in FIG. 7, the calculation control processing unit 6 specifies start data for continuously reproducing a plurality of pieces of moving image data, and the operation proceeds to step S402. In the present exemplary embodiment, the calculation control processing unit 6 sets six numerical values. The values “No,” “T0,” “T,” and “T1” are similar to those in the second exemplary embodiment.

The value “T2” is an elapsed icon illumination time. More specifically, the elapsed icon illumination time T2 represents a time that has elapsed since start of illuminating the first and second icons 601 and 602, and one of the first and second icon selection displays 603 and 604. The initial value for the elapsed icon illumination time T2 is set to 0. The calculation control processing unit 6 starts counting the elapsed icon illumination time T2 in step S703 in FIG. 8 (described below). The value “T3” is a maximum icon illumination time. More specifically, the maximum icon illumination time T3 represents the maximum time for which the first and second icons 601 and 602, and one of the first and second icon selection displays 603 and 604 can be illuminated. The maximum icon illumination time T3 is used to set a maximum time for which the operation unit 3 can receive an instruction for performing retroactive reproduction. In the present exemplary embodiment, the maximum icon illumination time T3 is set to 30 seconds and is compared with the elapsed icon illumination time T2 in step S707 in FIG. 8 (described below).

Since steps S402 to S404 and S502 in FIG. 7 are similar to those in the first and second exemplary embodiments, the description thereof will be omitted. In addition, in step S406 in FIG. 7, similar processing to that in the first exemplary embodiment is performed. Namely, if the calculation control processing unit 6 determines that the apparatus orientation information has not been changed (NO in step S406), the operation proceeds to step S407. Since steps S407 to S408 and S509 in FIG. 7 are similar to those in the first and second exemplary embodiments, the description thereof will be omitted. In contrast, if, as a result of the determination in step S406, the calculation control processing unit 6 determines that the apparatus orientation information has been changed (YES in step S406), the operation proceeds to step S702 in FIG. 8.

In step S702 in FIG. 8, the calculation control processing unit 6 displays the first and second icons 601 and 602 on the display unit 2. Further, the calculation control processing unit 6 displays the first icon selection display 603 or the second icon selection display 604 on the display unit 2. In addition, the calculation control processing unit 6 enables the operation unit 3 to receive selection of the first icon selection display 603 or the second icon selection display 604 and to receive confirmation of the selection of the first icon 601 or the second icon 602.

Next, in step S703 in FIG. 8, the calculation control processing unit 6 starts counting the elapsed time since displaying the first and second icons 601 and 602, and one of the first and second icon selection displays 603 and 604 on the display unit 2. Namely, the calculation control processing unit 6 causes the timer 7 to count the elapsed icon illumination time T2.

Next, in step S704 in FIG. 8, the calculation control processing unit 6 determines whether selection of the first icon 601 has been confirmed. As a result of the determination, if the calculation control processing unit 6 determines that selection of the first icon 601 has been confirmed (YES in step S704), the operation proceeds to step S709. In step S709, the calculation control processing unit 6 acquires information about the elapsed reproduction time T1 of the No-th moving image data currently reproduced. Then, in step S710, the calculation control processing unit 6 sets the retroactive reproduction time T0 to the elapsed reproduction time T1 of the No-th moving image data currently reproduced, and the operation proceeds to step S711.

If, as a result of the determination in step S704, the calculation control processing unit 6 determines that selection of the first icon 601 has not been confirmed (NO in step S704), the operation proceeds to step S705. In step S705, the calculation control processing unit 6 determines whether selection of the second icon 602 has been confirmed. If, as a result of the determination, the calculation control processing unit 6 determines that selection of the second icon 602 has not been confirmed (NO in step S705), the operation proceeds to step S707. In step S707, the calculation control processing unit 6 determines whether the elapsed icon illumination time T2 is equal to or more than the maximum icon illumination time T3. As a result of the determination, if the calculation control processing unit 6 determines that the elapsed icon illumination time T2 is less than the maximum icon illumination time T3, the operation returns to step S704.

In contrast, if, as result of the determination in step S707, the calculation control processing unit 6 determines that the elapsed icon illumination time T2 is equal to or more than the maximum icon illumination time T3 (YES in step S707), the operation proceeds to step S708. In step S708, the first and second icons 601 and 602, and one of the first and second icon selection displays 603 and 604 on the display unit 2 are hidden. In addition, the calculation control processing unit 6 disables the operation unit to receive selection of the first icon selection display 603 or the second icon selection display 604 and to receive confirmation of the first icon 601 or the second icon 602. Thus, since no retroactive reproduction can be performed, the operation returns to step S407 in FIG. 7.

If, as a result of the determination in step S705, the calculation control processing unit 6 determines that selection of the second icon 602 has been confirmed (YES in step S705), the operation proceeds to step S706 in FIG. 8. In step S706, the calculation control processing unit 6 acquires information about the elapsed reproduction time T1 of the No-th moving image data currently reproduced. Then in step S504 in FIG. 8, similar processing to that in the second exemplary embodiment is performed. Namely, if the calculation control processing unit 6 determines that the elapsed reproduction time T1 is equal to or more than the predetermined retroactive reproduction time T (YES in step S504), the calculation control processing unit 6 performs the processing in step S505 as described in the second exemplary embodiment. If, as a result of the determination in step S504, the calculation control processing unit 6 determines that the elapsed reproduction time T1 is less than the predetermined retroactive reproduction time T (NO in step S504), the operation proceeds to step S710.

Next, in step S711 in FIG. 8, the calculation control processing unit 6 brings back the currently-reproduced moving image data by the set retroactive reproduction time T0. Then, in step S712, the calculation control processing unit 6 sets the elapsed reproduction time T1 of the moving image data and the elapsed icon illumination time T2 to 0, and the operation returns to step S402. This processing is performed in order to start reproducing the moving image data in the subsequent step S502 and to restart counting the elapsed icon illumination time from 0 in step S703 when illumination of the icons is started.

As described above, according to the present exemplary embodiment, if the user rotates the moving image reproducing apparatus 1 in a state where the size of a moving image is reduced so that the orientation of the moving image reproducing apparatus 1 matches the vertical direction of the moving image, the user can arbitrarily determine whether to retroactively reproduce the moving image data. Thus, if the user does not need to retroactively reproduce the moving image, the user can reduce the viewing time by continuously reproducing the moving image without a change. If the user wishes to retroactively reproduce the moving image, the user can retroactively reproduce the moving image with a simple operation and view the currently-reproduced moving image without missing a desired scene.

A single hardware module may be used to perform control operations of the calculation control processing unit 6. Alternatively, the entire apparatus may be controlled by causing a plurality of hardware modules to perform the respective processes.

While the present invention has been described in detail based on exemplary embodiments, the present invention is not limited thereto. The present invention includes various modes without departing from the gist of the present invention. In addition, each of the above exemplary embodiments is only an exemplary embodiment of the present invention. Thus, two or more of the above exemplary embodiments may be combined as needed.

Further, the above exemplary embodiments of the present invention have been described using an example where the exemplary embodiments are applied to a moving image reproducing apparatus. However, the exemplary embodiments are not limited to such example. An exemplary embodiment is applicable to a display control apparatus capable of frequently changing the direction of a display screen. Namely, an exemplary embodiment of the present invention is applicable to a mobile telephone terminal, a mobile image viewer, a tablet personal computer, an electronic book reader, a game console, a mobile music player, and the like.

The exemplary embodiments of the present invention can also be realized by supplying software (a program) for implementing the functions of the above exemplary embodiments to a system or an apparatus via a network or one of various types of storage media and by causing a computer (or a CPU, a micro processing unit (MPU), or the like) of the system or the apparatus to read and execute the program. In such a case, the program or a storage medium storing the program constitutes an exemplary embodiment of the present invention.

According to the exemplary embodiments of the present invention, if an apparatus is rotated while reproducing a moving image, the user is prevented from failing to grasp the content of the moving image.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-105331 filed May 17, 2013, which is hereby incorporated by reference herein in its entirety.

What is claimed is:

1. A moving image reproducing apparatus comprising:
a reproduction unit configured to reproduce moving image data;
a display control unit configured to control a display unit to display a moving image relating to the moving image data reproduced by the reproduction unit;
a detection unit configured to detect an orientation of the display unit; and
a control unit configured to, if the detection unit has detected a change in the orientation of the display unit while the reproduction unit is reproducing the moving image data, control the reproduction unit to start reproducing the moving image data from a reproduction position prior to a reproduction position at a point of time when the detection unit has detected the change in the orientation.

2. The moving image reproducing apparatus according to claim 1, further comprising:
an acquisition unit configured to acquire orientation information about the moving image data; and
an image processing unit configured to perform display size change processing and rotation processing on the moving image relating to the moving image data, based on the orientation information about the moving image data acquired by the acquisition unit and on the orientation information about the display unit detected by the detection unit,
wherein the display control unit controls the display unit to display the moving image processed by the image processing unit from the reproduction position controlled by the control unit.

3. The moving image reproducing apparatus according to claim 1, wherein, if the detection unit has detected a change in the orientation of the display unit while the reproduction unit is reproducing the moving image data, the control unit controls the reproduction unit to start reproducing the moving image data from start of the moving image data.

4. The moving image reproducing apparatus according to claim 1, wherein, if the detection unit has detected a change in the orientation of the display unit while the reproduction unit is reproducing the moving image data, the control unit controls the reproduction unit to start reproducing the moving image data from the start of the moving image data or from a reproduction position brought back by a predetermined time.

5. The moving image reproducing apparatus according to claim 4, wherein, if the detection unit has detected a change in the orientation of the display unit while the reproduction unit is reproducing the moving image data and if the predetermined time or more has elapsed since the start of reproducing the moving image data by the reproduction unit, the control unit controls the reproduction unit to start reproducing the moving image data from the reproduction position brought back by the predetermined time.

6. The moving image reproducing apparatus according to claim 1, wherein, if the detection unit has detected a change in the orientation of the display unit while the reproduction unit is reproducing the moving image data, the display control unit controls the display unit to display a display item for receiving an instruction to start reproducing the moving image data from the reproduction position prior to the reproduction position at the point of time when the detection unit has detected the change in the orientation, and
wherein, in response to an operation relating to the display item performed by a user, the control unit controls the reproduction unit to start reproducing the moving image data from the reproduction position prior to the reproduction position at the point of time when the detection unit has detected the change in the orientation.

7. The moving image reproducing apparatus according to claim 6, wherein the display control unit controls the display unit to display an icon, as the display item, for selecting whether to reproduce the moving image data from the start thereof or from the reproduction position brought back by the predetermined time.

8. The moving image reproducing apparatus according to claim 1, wherein the moving image reproducing apparatus is a digital camera having an imaging unit.

9. The moving image reproducing apparatus according to claim 1, wherein the moving image reproducing apparatus is a mobile apparatus having a display unit.

10. The moving image reproducing apparatus according to claim 1, wherein the reproduction unit is capable of continuously reproducing a plurality of pieces of moving image data.

11. A method for controlling a moving image reproducing apparatus, the method comprising:
reproducing moving image data;
controlling a display unit to display a moving image relating to the reproduced moving image data;
detecting an orientation of the display unit; and
performing control, if a change in the orientation of the display unit has been detected while the moving image data is being reproduced, to start reproducing the moving image data from a reproduction position prior to a reproduction position at a point of time when the change in the orientation has been detected.

12. A non-transitory computer-readable storage medium storing a program for causing a computer to function as each unit in the moving image reproducing apparatus according to claim 1.
